(19) United States
(12) Patent Application Publication
(10) Pub. No.: US 2013/0163394 A1
(43) Pub. Date: Jun. 27, 2013

(54) Easy Wake System and Method

(71) Applicant: Leonor F. Loree, IV, Atlanta, GA (US)

(72) Inventor: Leonor F. Loree, IV, Atlanta, GA (US)

(21) Appl. No.: 13/336,789

(22) Filed: Dec. 23, 2011

(51) Int. Cl. G04G 11/00

(52) U.S. Cl. 368/256

(57) ABSTRACT

Disclosed embodiments are directed towards a system and method for awakening a user from a period of sleep by applying a stimulus of light for a period determined from a comparative analysis of the user's sleep stage and a desired wake time. One exemplary method includes setting an alarm time and then monitoring motion sensors to detect movements of the user that indicate the user is in a stage of light sleep. When it is determined that the user has entered a stage of light sleep, the alarm time may be compared with the timing of the light stage of sleep. If the alarm time coincides with the sleep stage timing, an alarm comprised of a gradually intensifying stimulus of light can be triggered to awaken the user. In some embodiments, the gradually intensifying stimulus of light can be made to simulate a dawn event of the sun rising.

### BACKGROUND

Feeling alert, well rested and refreshed after waking from a period of slumber is not the elusive, random result of sleep that so many sleepers think it is. There's a lot of science behind getting the most out of one's sleep. Poor diet, crying babies and cheap mattresses notwithstanding, a rejuvenating sleep experience that culminates in an easy awakening event will temporally correlate with the sleeper's natural circadian rhythm and sleep cycle.

A circadian rhythm is an internally driven, self-sustained biological temporal rhythm spanning roughly a 24-hour cycle in biochemical, physiological or behavioral processes. Some systems and methods have sought to manipulate a sleeper's unique circadian rhythm, or “body clock,” in an effort to adjust the sleeper's natural wake time to more closely match a desired wake time. One such system is known as a “dawn simulator.” Generally, a dawn simulator operates to entrain, or adjust, the beginning and/or ending of a sleeper's circadian rhythm to the environment by using an external cue in the form of a light source. By leveraging the light source, a dawn simulator may effectively synchronize a sleeper's endogenous (internal) time-keeping system (body clock) to a target sleep/wake cycle.

Most dawn simulators are essentially soundless alarm clocks designed to wake up the sleeper naturally by causing lights to gradually brighten over a period of time. The light source is typically brightened beginning from 30 minutes to 2 hours prior to the sleeper awakening and continues to brighten after the sleeper awakens. When used successfully, users are able to wake up easily at the simulated sunrise and experience a shift in their circadian rhythms that will cause them to enter the next sleep cycle earlier. The theory behind dawn simulation is based on the fact that early morning light signals are much more effective at advancing the biological clock than are light signals given at other times of day.

Other systems and methods may monitor the multiple sleep cycles experienced by a sleeper over a period of rest and adjust a wake up alarm to coincide, or nearly coincide, with a time at which the sleeper is experiencing shallow sleep. A given period of sleep may consist of several sleep cycles, with each cycle spanning a period of time that starts with a light or shallow state of unconsciousness, progresses to a deep state of unconsciousness, and then returns to the shallow state. If a sleeper is awakened during a deep state of sleep, he will require a longer adjustment time than usual and will inevitably experience adverse effects on alertness and energy levels. For this reason, systems and methods that monitor sleep cycles to trigger wake up alarms usually seek to match an alarm with a shallow state of sleep.

Every person has a unique circadian rhythm that, without manipulation, will cause the person to consistently go to sleep around a certain time and awaken around a certain time thereafter. Dawn simulators can be used to delay or advance the overall timing of a user's circadian rhythm, thereby adjusting the natural times at which the user wants to go to sleep or awaken. Further, by simulating a natural sunrise, dawn simulators are effective at “gently” and gradually awakening a user. Dawn simulators, however, are not as effective or efficient at gradually awakening a user when the user is in a deep state of sleep.

Therefore, what is needed in the art is a system that integrates a dawn simulator with a device for monitoring sleep cycles. Further, what is needed in the art is a method for determining when an individual is in a shallow state of sleep, or will be in a shallow state of sleep, and then timing the application of a dawn simulator to awaken the individual.

### BRIEF SUMMARY

The presently disclosed embodiments, as well as features and aspects thereof, are directed towards a system and method for awakening a user from a period of sleep by applying a stimulus of light for a period determined from a comparative analysis of the user's sleep stage and a desired wake time. One exemplary method includes setting an alarm for a desired user wake up time in a personal device that comprises a motion sensor. The motion sensor may detect the movements of the user when the user is in a stage of light sleep, such as a rapid eye movement (“REM”) stage. The motion sensor signals may be continually monitored and, when it is determined from the signals that the user has entered a stage of light sleep, the alarm time may be compared with the timing of the light stage of sleep (the “timing” of the sleep stage being a beginning time, an ending time and the period of time defined between). If the alarm time coincides with the timing of the entered stage of light sleep, an alarm comprised of a gradually intensifying stimulus of light can be triggered to awaken the user. Notably, in some embodiments, the gradually intensifying stimulus of light can be made to simulate a dawn event of the sun rising.

Another exemplary embodiment includes setting an alarm time in a personal device comprising a motion sensor, wherein the alarm time represents a desired wake up time for a user of the personal device. Signals generated by the motion sensor are monitored to determine that the user is generating an increase in movement, thus indicating that a stage of light sleep has been entered by the user. A master sleep cycle curve is updated with data collected from the monitored signals and then analyzed to predict an upcoming stage of light sleep that the user may enter. Subsequently, an alarm time is compared to the predicted timing of the upcoming stage of light sleep and, if the alarm time coincides with the timing of the upcoming stage of light sleep, a start time is calculated for triggering an alarm to awaken the user. At the start time, an alarm comprising a gradually intensifying stimulus of light is initiated to simulate a dawn that culminates to awaken the user coincidentally with his entering the upcoming stage of light sleep.

Notably, the exemplary embodiments described herein are generally directed toward applications for awakening a user from an identified sleep stage via a gradually intensifying light, i.e. a dawn simulation. It will be understood, however, that not all embodiments are limited to applications for awakening a user via a gradually intensifying light source. For example, it is envisioned that some embodiments may include features useful for assisting a user in falling to sleep such as, but not limited to, gradually decreasing light source intensity, i.e. a sunset simulation.

### BRIEF DESCRIPTION OF THE SEVERAL VIEWS OF THE DRAWING

In the Figures, like reference numerals refer to like parts throughout the various views unless otherwise indicated.

FIG. 1 is an illustration of an exemplary phase response curve that may be leveraged by a dawn simulator module to modify a user's sleep entry and wake times;

FIG. 2 is an illustration of an exemplary sleep stage pattern that may be leveraged by a sleep tracker module to recognize a user's sleep stage and adjust an alarm time to coincide with an optimal wake time for the user;

FIG. 3 is a functional block diagram illustrating components of an exemplary embodiment of a system for awakening a user from a period of sleep by applying a stimulus of light for a period determined from a comparative analysis of the user's sleep cycles and a desired wake time;

FIG. 4 is an illustration of the exemplary sleep stage pattern of FIG. 2, shown with a desired user wake up time of roughly 5:15 a.m;

FIG. 5 is an illustration of the exemplary sleep stage pattern of FIG. 2, depicted after an advance phase shift of roughly 45 minutes;

FIG. 6 is an illustration of the exemplary sleep stage pattern of FIG. 2, shown with a desired user wake up time of roughly 6:00 a.m;

FIG. 7 is an illustration of the exemplary sleep stage pattern of FIG. 2 and the light intensity curve of FIG. 6 extended and modified respectively, according to application of a “snooze” feature;

FIG. 8 is an illustration of the exemplary sleep stage pattern of FIG. 2 and the light intensity curve of FIG. 6 extended and modified respectively, according to application of a “snooze” feature;

FIG. 9 is an illustration of the exemplary sleep stage pattern of FIG. 2 and the light intensity curve of FIG. 6 extended and modified respectively, according to application of a “snooze” feature;

FIG. 10 is a logical flowchart illustrating an embodiment of a method for awakening a user from a period of sleep by applying a stimulus of light for a period determined from a comparative analysis of the user's sleep cycles and a desired wake time; and

FIG. 11 is a logical flowchart illustrating an embodiment of a method for awakening a user from a period of sleep by applying a stimulus of light for a period determined from a comparative analysis of the user's sleep cycles and a desired wake time.

### DETAILED DESCRIPTION

Aspects, features and advantages of several exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms such as, for example, “will,” “will not,” “shall,” “shall not,” “must” and “must not” are not meant to limit the scope of the present invention as the embodiments disclosed herein are merely exemplary.

The word “exemplary” is used herein to mean “serving as an example, instance, or illustration.” Any aspect described herein as “exemplary” is not necessarily to be construed as exclusive, preferred or advantageous over other aspects.

The terms “sleeper” and “user” are generally used interchangeably in this specification, unless indicated otherwise.

In this description, the terms “phase,” “sleep phase” and “sleep period” are used interchangeably to represent a block of time, from sleep entry to awakening, during which a person sleeps. The terms “stage,” “sleep stage,” “light stage” and “deep stage” are used to describe smaller spans of time within the larger “sleep period” that may combine in various combinations to form one or more “sleep cycles.” As such, one of ordinary skill in the art will recognize that multiple “sleep stages” may be combined to form a “sleep cycle” and multiple “sleep cycles” may be combined to form a “sleep period.”

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content,” as referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet or local WiFi with other systems by way of the signal).

In this description, the term “Easy Wake Device” (“EWD”) is used to describe any portable device (“PD”) operating on a limited capacity power supply, such as a battery. Although battery operated PDs have been in use for decades, technological advances in rechargeable batteries coupled with the advent of third generation (“3G”) wireless technology have enabled numerous PDs with multiple capabilities. Therefore, a PD operable to function as an EWD may be a cellular telephone, a satellite telephone, a pager, a PDA, a smartphone, a navigation device, a smartbook or reader, a media player, a wristwatch, a combination of the aforementioned devices, a laptop computer with a wireless connection, among others. It will be appreciated that various embodiments, aspects and features of the various embodiments may also be incorporated into non-portable devices or portable devices that are intended to be plugged into an outlet for receiving power, in addition to or in lieu of utilizing the limited capacity power supply.

The presently disclosed embodiments, as well as features and aspects thereof, are directed towards providing a system and method for determining the optimal moments to awaken a user during the sleep cycle and, more specifically, it relates to an apparatus and method that detects motion of a sleeping user to determine the user's sleep cycle and may alter the timing of an alarm condition based on the detection of the motion. In some embodiments, a dawn simulator component operable to mimic a sunrise may be leveraged in conjunction with a module for monitoring user motion. The dawn simulator may be used as the alarm condition for awakening the user, a device for shifting the natural sleep cycle of the user or a combination thereof.

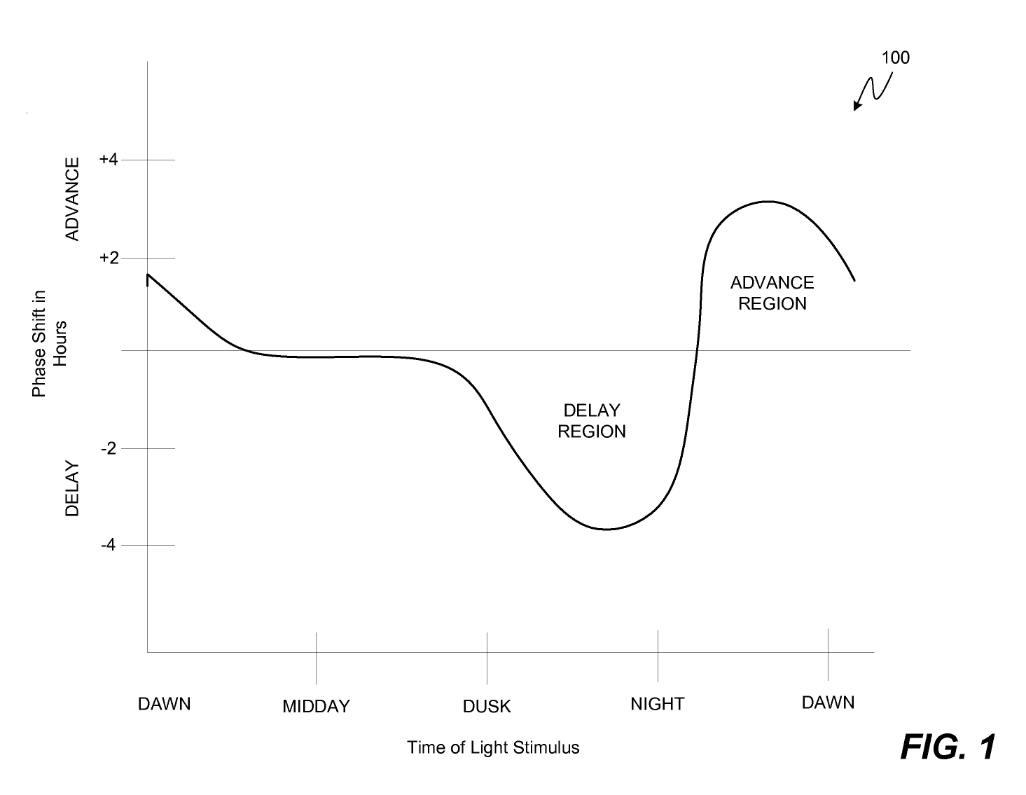

FIG. 1 is an illustration of an exemplary phase response curve (“PRC”) that may be leveraged by a dawn simulator module to modify a user's sleep entry and wake times. A PRC illustrates the relationship between the timing and the effect of a treatment, such as exposure to light, designed to affect a sleeper's circadian rhythm. A person's circadian rhythm determines the natural sleep entry and wake times that define a preferred daily sleep period.

Recognizing a user's unique circadian rhythm, a dawn simulator module may be used to adjust the entry and wake timing of a sleep period, either delaying it to later in the day or advancing it, by exposing a user to a light source that simulates the sun rising. For example, a dawn simulator may be used by extreme morning people who want to delay the timing of their preferred sleep period so that they don't wake up at too early an hour. Conversely, evening types, i.e. “night owls,” may seek the benefits of a dawn simulator to advance the preferred sleep period such that they actually want to enter sleep at an earlier hour in the evening.

The times depicted along the x-axis of a PRC are general in nature and represent periods of roughly six hours: dawn—mid-day—dusk—night—dawn. Notably, these times do not refer to actual sunrise times or clock times. Rather, each person has his own endogenous circadian “clock” and chronotype. As such, dawn in the exemplary illustration refers to a particular person's time of spontaneous awakening when well-rested and sleeping regularly. The PRC shows when a stimulus, in this case light to the eyes, will effect a change in the person's preferred period of sleep, i.e. an advance or a delay as explained briefly above. Notably, the curve's highest point coincides with the subject's lowest body temperature.

Generally, starting about two hours before a person's preferred time of sleep entry, exposure to bright light will delay the circadian phase, causing a later sleep entry time and, consequently, a later wake-up time. This delaying effect gets stronger as evening progresses. About five hours after usual bedtime, coinciding with the lowest point of the body temperature rhythm (also known as the body temperature nadir), the PRC peaks and the opportunity for effect changes abruptly from phase delay to phase advance. Immediately after this peak, bright light exposure has its greatest phase-advancing effect, causing earlier wake-up and, subsequently, earlier sleep entry into the next sleep period. Notably, the phase shifting effect diminishes until about two hours after spontaneous wake-up time, when it reaches zero. During the period between two hours after usual wake-up time and two hours before usual bedtime, bright light exposure has little or no effect on circadian phase (slight effects generally cancelling each other out).

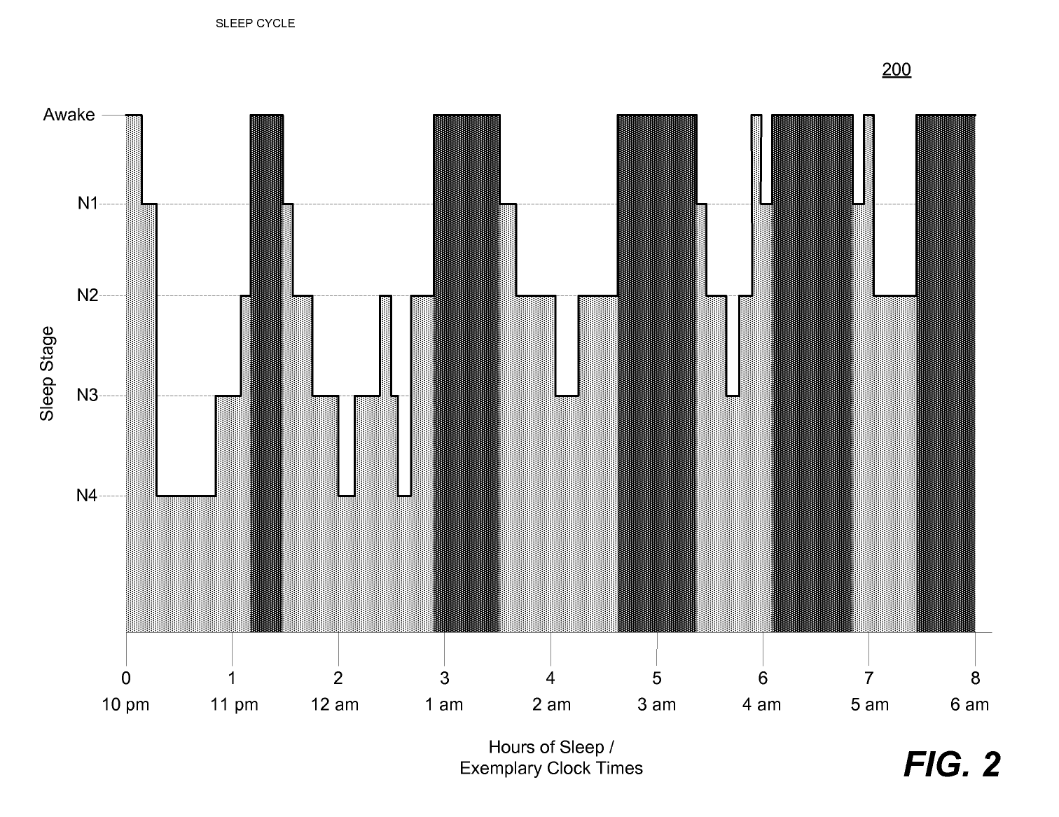

FIG. 2 is an illustration of an exemplary sleep stage pattern 200 that may be leveraged by a sleep tracker module to recognize a user's sleep stage and adjust an alarm time to coincide with an optimal wake time for the user. The entire pattern illustrated in FIG. 2 may represent an exemplary sleeper's sleep period beginning with a sleep entry time at 10:00 p.m. and a natural wake time at 6:00 a.m. Moreover, it will be understood that, in the context of this description, sleep stage pattern 200 may represent a specific sleep stage pattern monitored and recognized by a sleep tracker module 118 over a given sleep period or, alternatively, a master sleep stage pattern that is the result of aggregate data collected by a sleep tracker module 118 over multiple sleep periods.

The sleep period may be considered an aggregate of successive sleep cycles, each containing multiple successive sleep stages ending in a light stage of sleep known in the art as a rapid eye movement (“REM”) stage. The REM stages are depicted in the FIG. 2 illustration as black columns and are understood in the art to coincide with the most optimum times for awakening from a sleep period. In the illustration, it can be seen that there are five sleep cycles running approximately from hours 0 to 1.5; 1.5 to 3.5; 3.5 to 5.3; 5.3 to 6.8; and 6.8 to 8.

Each sleep cycle may contain a combination of sleep stages, with the REM and N1 stages representing the lightest stages of sleep and the N2, N3 and N4 stages representing deeper stages of sleep, respectively. As described above relative to the FIG. 1 illustration, the entire exemplary sleep period illustrated in FIG. 2 from the sleep entry at 10:00 p.m. to the natural awake time eight hours later at 6:00 a.m. may correlate with the user's circadian rhythm.

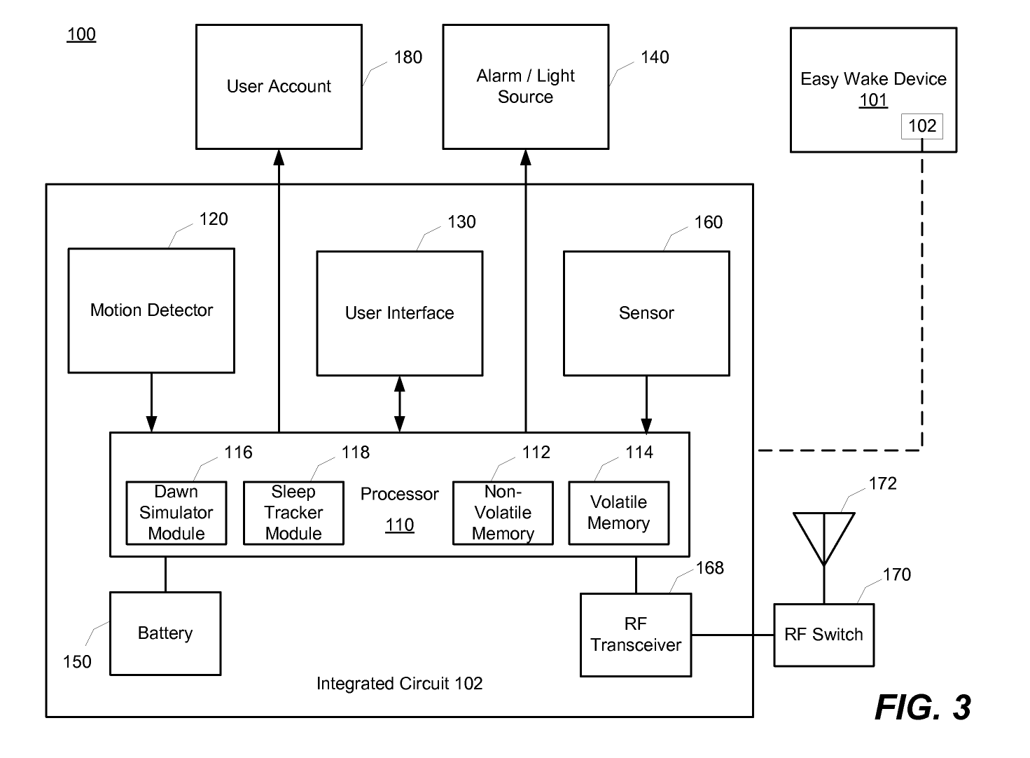

FIG. 3 is a functional block diagram illustrating components of an exemplary embodiment of a system for awakening a user from a period of sleep by applying a stimulus of light for a period determined from a comparative analysis of the user's sleep cycles and a desired wake time. The easy wake device (“EWD”) 101 includes a chip 102. The chip 102 includes at least one processor 110 that is/are powered through a battery 150. The FIG. 3 diagram further indicates that a radio frequency (“RF”) transceiver 168 may be coupled to the processor 110. An RF switch 170 may be coupled to the RF transceiver 168 and an RF antenna 172 for wireless communication with a complimentary component of the system such as, but not limited to, user account 180.

The processor 110 interfaces to a motion detector 120, a user interface 130, a user account 180 and an alarm 140. Notably, although the alarm 140 is depicted as residing “off chip,” it is envisioned that the alarm 140, or aspects of the alarm 140, may reside on the chip 102 in some embodiments. More specifically, for embodiments that leverage a light source for a dawn simulation and/or a sunset simulation, the alarm 140 may be a light source comprised within EWD 101 or, alternatively, could be a remote light source in communication with EWD 101 via a wired connection or wireless connection (such as RF). Similarly, although the user account 180 is depicted as residing “off chip,” it is envisioned that the user account 180, or aspects of the user account 180, may reside in the memory 112, 114 of the EWD 101 in some embodiments or, in other embodiments, in a memory source accessible by EWD 101 via a wired connection or wireless connection.

The motion detector 120 can be an accelerometer or other motion sensing device embedded in device 101, or may be an external device that is wirelessly or hard wired coupled to the processor 110. The motion detector 120 may also utilize other technology for detecting movement of the sleeping entity, such as measuring of skin resistance, measuring electrical energy in the body and or the brain, using video cameras and video signal processing, etc. The user interface 130 can include a variety of mechanisms but, in general, includes a mechanism for a user to provide input to the processor 102 for modifying aspects of the dawn simulator module 116 and/or sleep tracker module 118. For instance, the dawn simulator module 116 may be modified by the user to change the duration of a dawn simulation and/or sunset simulation, the light intensity of simulation, the timing of a dawn simulation and/or sunset simulation, etc.

The user interface 130 can further provide for the processor to display status, prompts and results to the user, query the user account 180, update user account 180, etc. In certain embodiments, the user interface 130 may include a series of buttons and an LCD, LED or electroluminescence display. However, it should be appreciated that embodiments are not limited to any particular user interface 130 mechanisms and other technologies can be employed without departing from the spirit and scope of the disclosure. Such technologies can include voice actuators, touch sensitive screens, text to audio conversions and speakers, etc.

The processor 110 further includes volatile memory 114 and non-volatile memory 112. The volatile memory 114 may include RAM, EEPROM, bubble memory or other volatile memory technologies and the non-volatile memory 112 may include ROM, EPROM, PROM, Gate Arrays or other similar technologies, as is understood in the art. The non-volatile memory 112 houses a programs and applications including instructions that are executed by the processor 110 at the request of the dawn simulator module 116 and/or sleep tracker module 118. Such instructions provide the intelligence for the processor 110 in responding to inputs from the modules 116, 118 that may be in communication with the motion detector 120, the user interface 130 and the alarm 140. The volatile memory 114 is used for storing configuration parameters such as the current time, alarm settings, modes of operation or the like.

It is further envisioned that in some embodiments the chip 102 may comprise one or more sensors 160 operable to sense temperature, light, etc. Temperature sensors 160, for instance, may be positioned such that the body temperature of a user can be monitored in an effort to identify various points within the circadian rhythm of the user, as is described above (peaks and nadirs). The temperature readings taken by the temperature sensors 160 may be leveraged by the dawn simulator module 116 to determine the optimum time for applying a stimulus of light to wake the user or, in some embodiments, to affect a desirable phase shift in the sleep period of the user. In other embodiments, light sensors 160 such as photodiodes may be used by the sleep tracker module 118 to recognize an ongoing dawn simulation which may, or may not, be administered by a separate light source 140. The photodiode sensors 160, recognizing that a dawn simulation is underway, may cause the sleep tracker module 118 to analyze a user's sleep stage and preempt the dawn simulation with an alarm better mapped to a light stage of sleep and a predetermined wake up time.

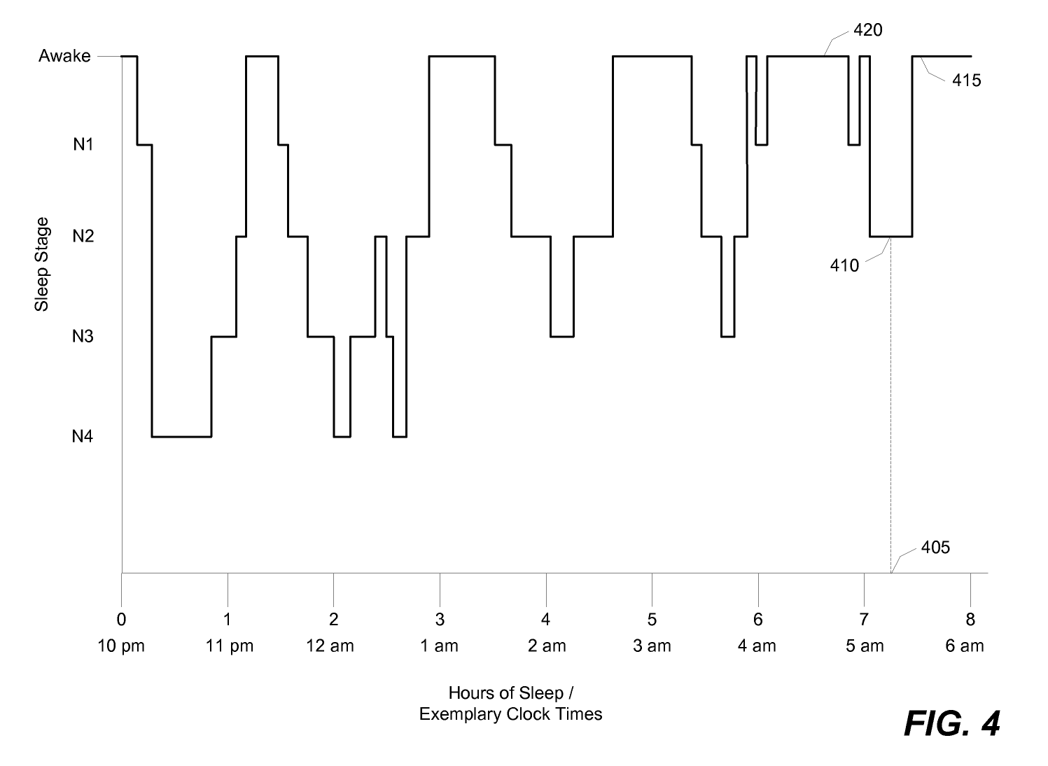

FIG. 4 is an illustration of the exemplary sleep stage pattern 200 of FIG. 2, shown with a desired user wake up time 405 of roughly 5:15 a.m. For the purposes of the FIG. 4 illustration, the entire sleep period ranging from 10:00 p.m. at hour “0” to 6:00 a.m. at hour “8” is assumed to correlate with a given subject's circadian rhythm. That is, for the purposes of illustration, the given user associated with the sleep stage pattern 200 may naturally wake up at or around the eighth hour. Notably, however, the user's desired wake up time 405 correlates with a deeper sleep stage 410 that is less optimal for awakening a user. As such, an embodiment leveraging the sleep tracker module 118 aspects may monitor the sleep stages and adjust the wake up alarm time to correlate with one or the other of stages 415 and 420. Notably, it is envisioned that the alarm in certain embodiments will comprise a dawn simulation.

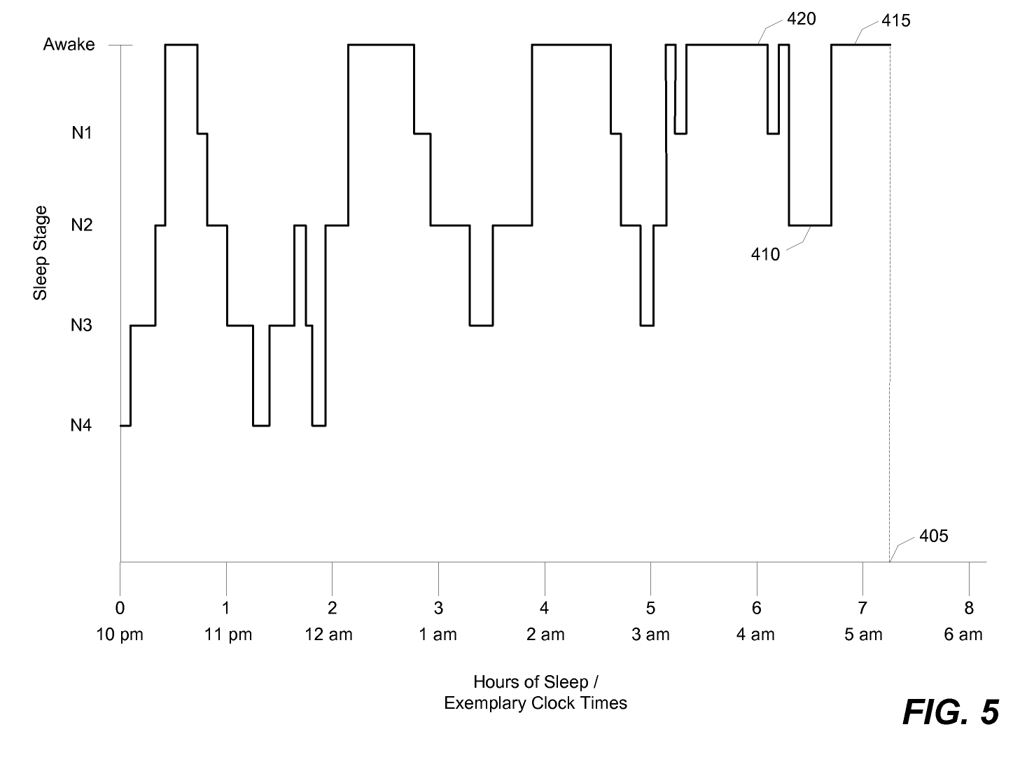

Turning now to FIG. 5, the exemplary sleep stage pattern 200 of FIG. 2 is depicted after an advance phase shift of roughly 45 minutes. As described above, the advance shift in the sleep period represented by the pattern 200 may be accomplished by dawn simulator module 116 triggering a dawn simulation, or other light-based stimulus, at or around a certain time during the user's circadian rhythm (see FIG. 1). Notably, by shifting the user's sleep period back by 45 minutes, the circadian rhythm may be caused to end more closely to the desired wake time 405 of 5:15 a.m., which correlates more closely with REM stage 415. As such, the sleep tracker module 118 may better leverage data monitored from the various stages and trigger a wake up alarm at, or more closely to, the desired wake time 405.

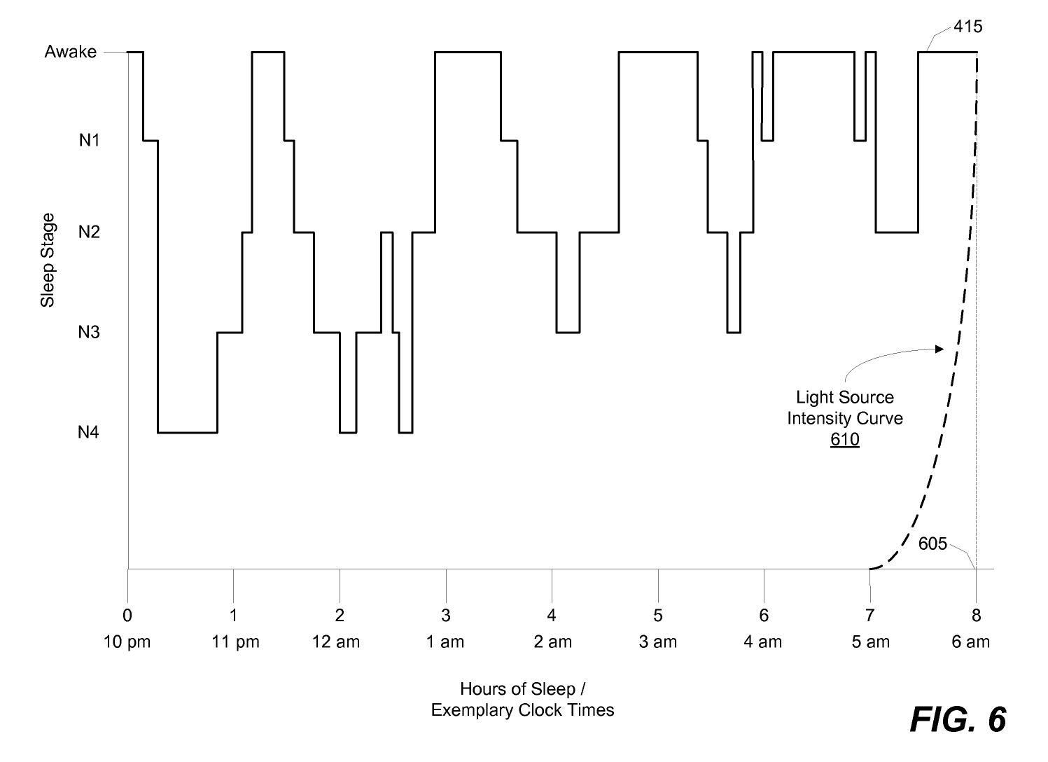

FIG. 6 is an illustration of the exemplary sleep stage pattern 200 of FIG. 2, shown with a desired user wake up time 605 of roughly 6:00 a.m. Notably, the 6:00 a.m. wake up time 605 maps closely to the natural wake time associated with the user's circadian rhythm. In some embodiments, the sleep tracker module 118 may recognize that the wake up time 605 correlates with a REM stage 415 and trigger an alarm accordingly. It is envisioned, however, that the sleep tracker module 118 in some embodiments may predict the upcoming REM stage 415, based on analysis of previously collected sleep stage data, and then trigger the dawn simulator module 116 to begin application of a dawn simulation prior to the wake up time 605.

As will be understood by one of ordinary skill in the art, the dawn simulation may begin at such time that the simulation will crescendo or culminate at or near the desired wake up time 605, thereby causing the user to awaken from his sleep period at an optimal time without need for auditory alarms. As can be seen in the depiction, the dawn simulation is represented by a light source intensity curve 610 that gets brighter as the wake up time draws near, hence the term “dawn” simulation. However, it is envisioned that some embodiments may not gradually increase the light intensity but, rather, simply apply a light source such as, but not limited to, a light aspect of the EWD 101, a bedroom lamp, etc.

For example, in some embodiments, an alarm may be set in the EWD 101 for a time that the user desires to be awakened in order to go to the bathroom, check on a sick child, administer medicine or perform some other task in the middle of the user's sleep period. In such situations, it is envisioned that it may be desirable for the user to be abruptly awakened via instantaneous “switching on” of a light or other alarm. In this way, embodiments may be leveraged to preempt a child wetting his bed, spiking a fever, etc. Moreover, some embodiments may be configured to receive data indicative of previous events (such as a bed wetting, for example), map the data to the user's sleep cycles and then trigger future alarms to preempt similar events in the future. Notably, it will be understood that any given embodiment may include one or more alarms and, as such, it is envisioned that certain embodiments may be suitable for sleep phase applications requiring that more than one alarm be leveraged. For instance, certain embodiments may be operable to provide an alarm for awakening a user in the middle of the sleep phase and then subsequent alarm(s) for awakening the user at a time(s) thereafter.

Returning to the FIG. 6 illustration, the dawn simulation is depicted to begin about an hour ahead of the target wake up time 605, however, this duration for the simulation is offered for exemplary purposes only and will not be construed to limit the application or duration of a dawn simulation aspect. It will also be appreciated that in some embodiments, the dawn simulator and the sleep cycle detector work in concert with each other to develop good sleep habits in an individual and causing the individual's natural tendencies to have shallow sleep cycles coinciding with desired wakeup times. As such, although an embodiment may include the dawn simulation working with the sleep cycle tracking technology, other alarm mechanisms may also be employed along with the dawn simulation, such as gentle and gradually increasing in volume noise generators, buzzers, vibrators, music, environmental temperature or other environmental settings, etc. Thus while the dawn simulator may be used for adjusting or maintaining circadian rhythms, the alarm is ultimately used to awaken the individual if necessary.

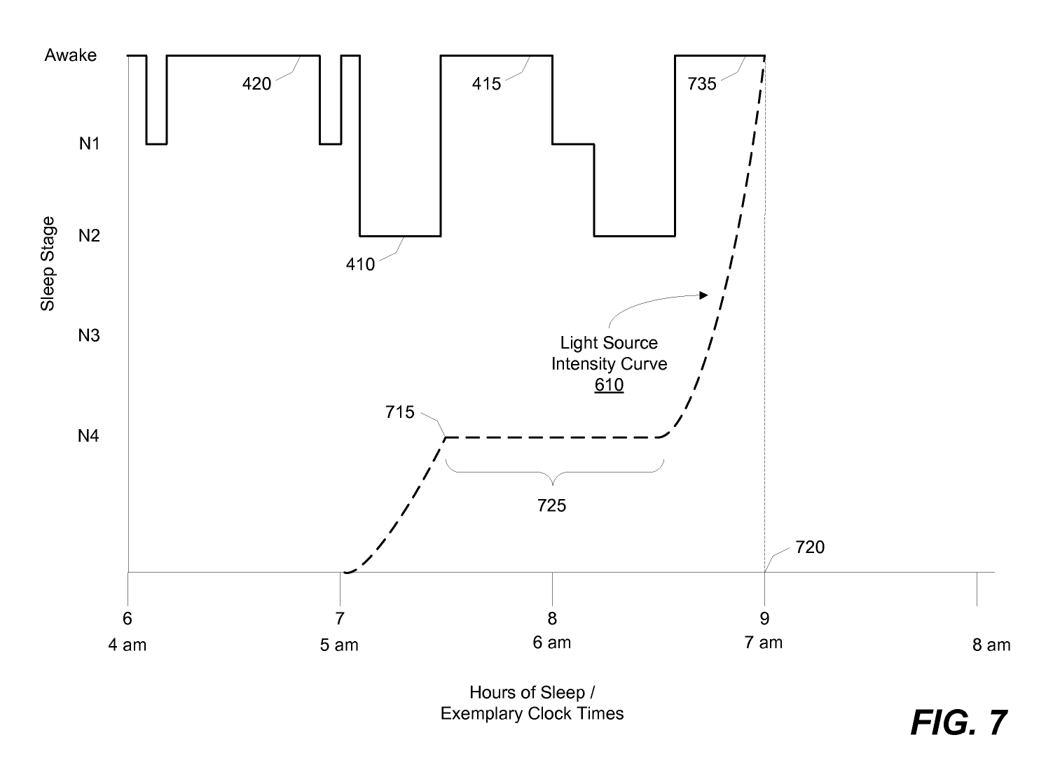

Turning now to FIG. 7, the exemplary sleep stage pattern 200 of FIG. 2 is extended and the light intensity curve of FIG. 6 is modified according to application of a “snooze” feature. As described above, the dawn simulator 116 may have triggered the beginning of a dawn simulation at 5:00 a.m. to culminate at a desired wake up time 605 of 6:00 a.m. At point 715, however, the user may have elected to delay or “snooze” the dawn simulation, thereby retarding the previously set wake up time 605 by an hour, for example, to an amended wake up time 720 of 7:00 a.m. In such a scenario, it is envisioned that some embodiments may hold the light intensity constant for a period 725 and then resume the dawn simulation beginning at a time point 730 such that the simulation will crescendo at, or near, the amended wake up time 720.

Notably, the sleep tracker module 118, as described prior, may further adjust the wake up time 720 to ensure that it coincides with a REM stage, such as stage 735. It will be understood that stage 735, or any stage with a sleep cycle of a user, may be predicted based on analysis of past sleep periods, cycles and stages or determined from real-time monitoring of user movement.

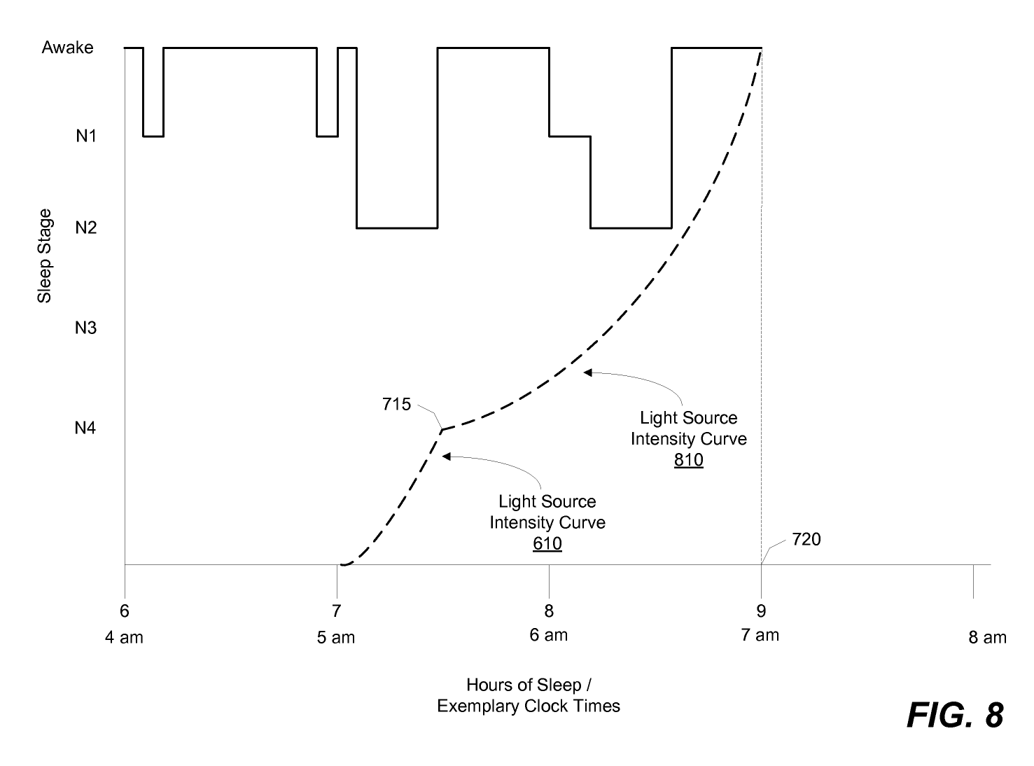

Turning now to FIG. 8, the exemplary sleep stage pattern 200 of FIG. 2 is extended and the light intensity curve of FIG. 6 is modified according to application of a “snooze” feature. It is envisioned that some embodiments may simply continue the dawn simulation by altering the slope of the light intensity curve 810 such that it is extended in duration to culminate at the modified wake up time 720.

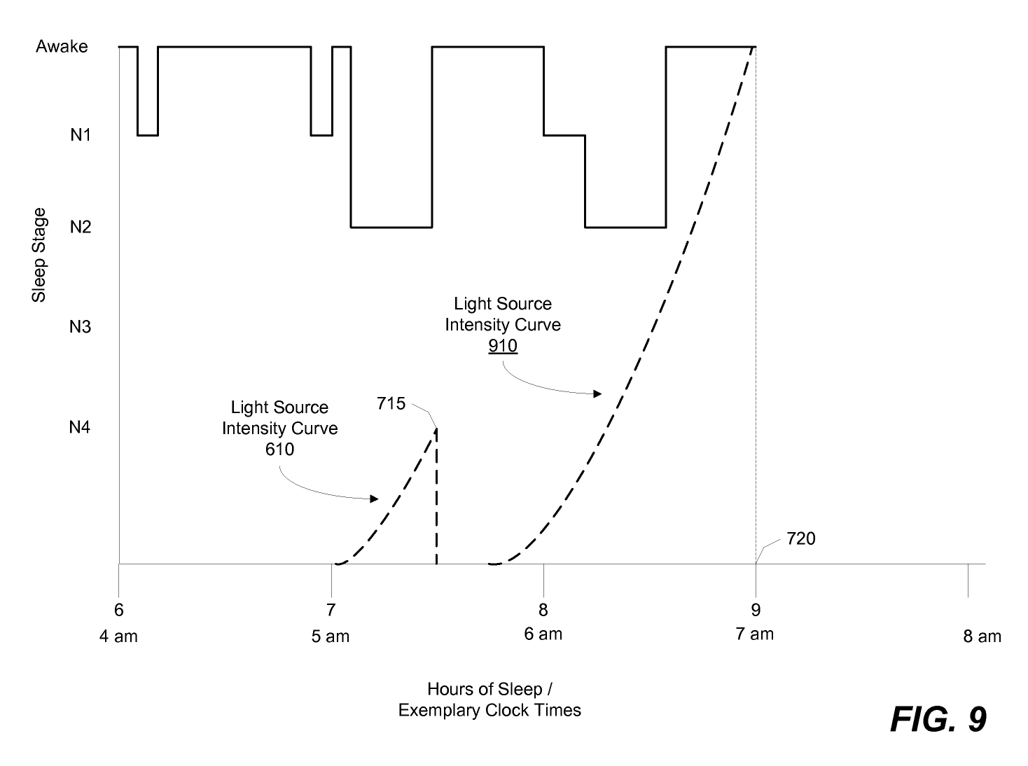

Turning to FIG. 9, it is further envisioned that other embodiments may simply end the dawn simulation 610 at the point of snooze 715 and then trigger a new dawn simulation 910 to culminate at the amended wake up time 720.

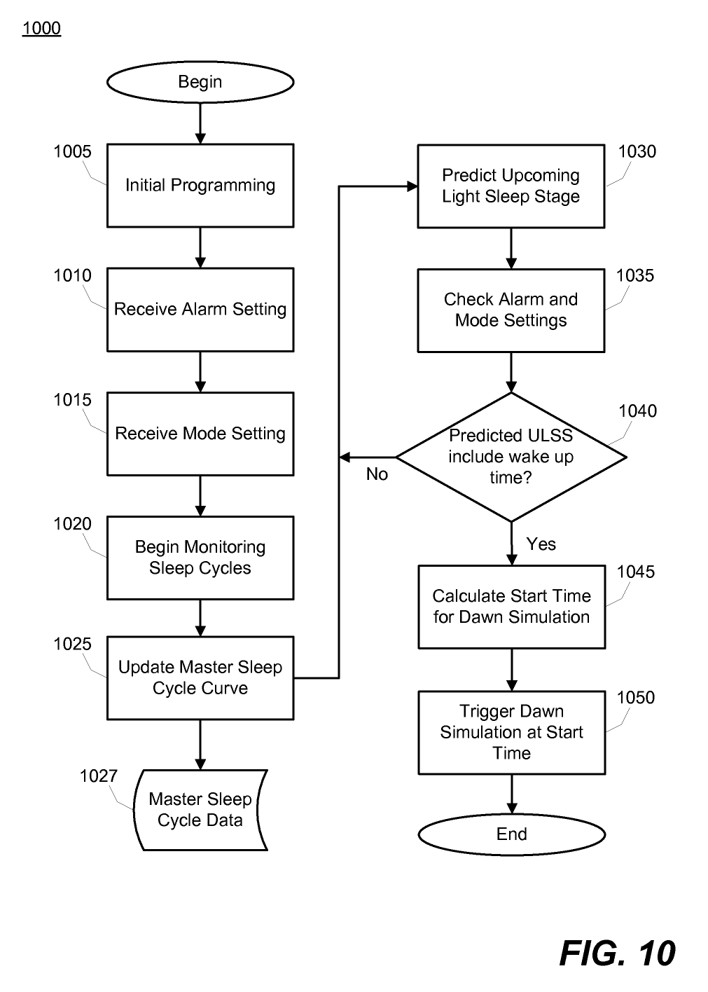

FIG. 10 is a logical flowchart illustrating an embodiment of a method for awakening a user from a period of sleep by applying a stimulus of light for a period determined from a comparative analysis of the user's sleep cycles and a desired wake time. The illustrated process 1000 begins at block 1005 by conducting an initial programming of the device 101. The initial programming, among other things, may include a user entering the present local time and date as well as any user configurable parameters such as alarm notifications, text configurations, display configurations, or the like. At block 1010, the user can then program the device 101 with alarm settings. The alarm settings can include identifying a preferred time to be awakened, a window or threshold period of time or a number of desired sleep cycles for the advancement or retardation of alarms proximate to shallow sleep cycles, duration of dawn simulation curves (in units time, sleep cycles, intensity, etc), the type of alarm or the like, such as enabling or disabling the use of audible or other alarms in conjunction with the dawn simulator, enable or disable dawn simulator, enable or disable sleep tracking operation, etc. At block 1015, the user can also program the device with mode settings. The mode settings can include setting the device to wake the user after a predetermined number of sleep cycles, threshold times, or the like. In some embodiments, the alarm settings and the mode settings can be accomplished simultaneously. Once the device 101 is programmed, at block 1020 the sleep tracker module 118 of device 101 may enter into monitoring mode and begin to track entry and exit of sleep stages by the user. The monitoring mode can be automatically triggered in accordance with the alarm and mode settings or can be manually triggered by the user when the user retires.

As the device 101 monitors the sleep stages, in some embodiments the monitored data may be collected and used at block 1025 to update an empirically developed master sleep cycle curve 1027. Also, in some embodiments, the monitored data may be collected and stored in a user account 180. Notably, a master sleep cycle curve 1027 may be stored in the user account 180, but such is not required in all embodiments. At block 1030, the master sleep cycle curve 1027 may be analyzed against the presently monitored sleep cycle of the user to identify an upcoming or future REM stage (a “light” sleep stage, as opposed to a “deep” sleep stage). Once the likely timing of an upcoming REM stage is determined, alarm and mode settings can be checked at block 1035 and, at decision block 1040, it can be determined whether an alarm time will coincide with the upcoming REM stage. If no alarm setting coincides with the timing of the predicted REM stage, then the “NO” branch is followed from decision block 1040 back to block 1030 and the next REM stage is predicted.

If, however, an alarm setting does coincide with the timing of the predicted REM stage, then the “YES” branch is followed to block 1045 and a start time for a dawn simulation is calculated such that the simulation will culminate with the predicted REM stage. At block 1050, the dawn simulation is triggered to begin at the calculated time. Notably, as the dawn simulation progresses and the light generated by the light source intensifies simultaneously with the sleeper entering the REM stage, thus simulating a natural dawn at the end of the user's circadian rhythm, the user will be prompted to awaken. It should be appreciated that the term “predicted REM stage” can include simply monitoring the movement of the subject to detect an approaching or existing REM stage, to more complicated actions that may include analyzing previous sleep cycle timings, analyzing previously recorded data, as well as monitoring any of a variety of other parameters including temperature of the subject, noise, degree of motions, frequency of motions, etc.

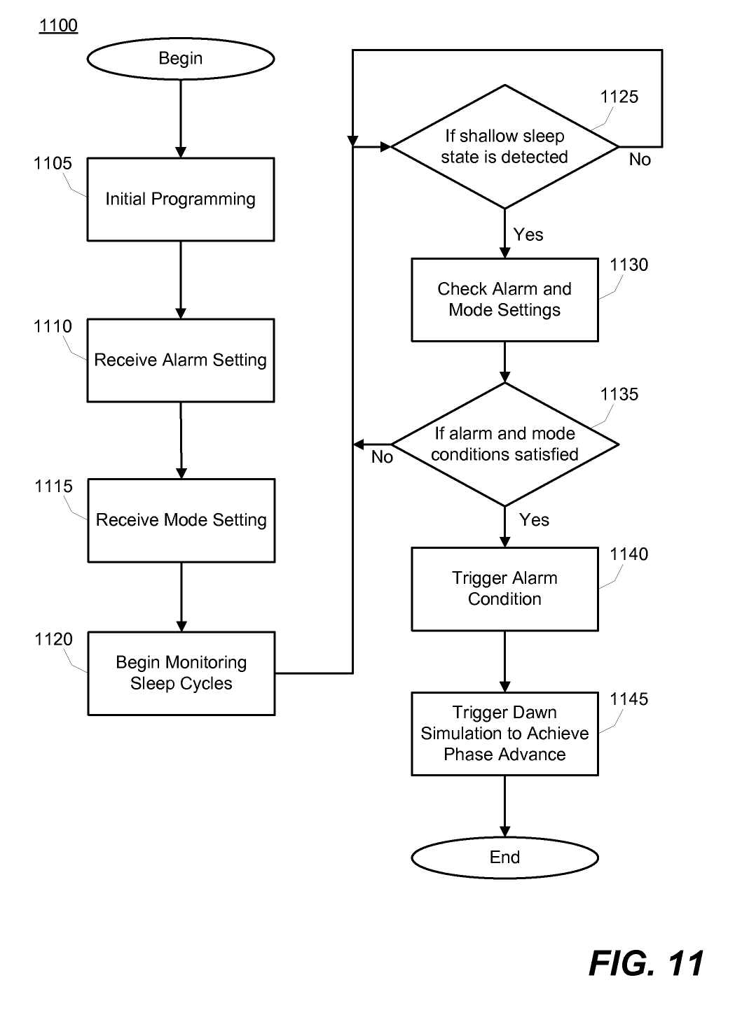

FIG. 11 is a logical flowchart illustrating an embodiment of a method for awakening a user from a period of sleep by applying a stimulus of light for a period determined from a comparative analysis of the user's sleep cycles and a desired wake time. The illustrated process 1100 begins at block 1105 by conducting an initial programming of the device 101. The initial programming, among other things, may include a user entering the present local time and date as well as any user configurable parameters such as alarm notifications, text configurations or the like. At block 1110, the user can then program the device 101 with alarm settings. The alarm settings can include identifying a preferred time to be awakened, a window or threshold period of time, a number of desired sleep cycles, the type of alarm or the like. At block 1115, the user can also program the device with mode settings. The mode settings can include setting the device to wake the user after a predetermined number of sleep cycles, threshold times, or the like. In some embodiments, the alarm settings and the mode settings can be accomplished simultaneously. Once the device 101 is programmed, at block 1120 the sleep tracker module 118 of device 101 may enter into monitoring mode and begin to track entry and exit of sleep stages by the user. The monitoring mode can be automatically triggered in accordance with the alarm and mode settings or can be manually triggered by the user when the user retires. Notably, the sleep tracker module 118 may monitor and track sleep stages of the user in some embodiments or, in other embodiments, may simply receive a signal that is indicative of a certain sleep stage. A trigger signal indicative of a sleep stage or other parameter related to the user's sleep phase may be generated from a component within the EWD 101 or generated from a component external to the EWD 101.

In the monitoring mode at decision block 1125, if the sleep tracker module 118 detects that the user is in a shallow state of sleep, such as by receiving an input from the motion detector 120, the sleep tracker module 118 checks the alarm and mode settings at block 1130 to determine if the alarm should be triggered. Otherwise, the monitoring mode is continued. If the alarm and mode settings are satisfied at decision block 1135 (i.e., shallow sleep stage is detected within the threshold time of the alarm setting or a specified number of sleep cycles is reached), then an alarm is triggered at block 1140. Otherwise, the monitoring mode continues. Once the alarm is triggered at block 1140, at block 1145 the dawn simulator module 116 may be prompted to initiate a dawn simulation in order to awaken the user. The dawn simulation of block 1145 may span a short amount of time in some embodiments in an effort to simply awaken the user while still in the shallow stage of sleep. Notably, however, it is envisioned that in other embodiments the dawn simulation of block 1145 may be used to not only awaken the user gradually, but also to affect a phase shift in the user's circadian rhythm.

Systems, devices and methods for the applying a stimulus of light for a period determined from a comparative analysis of the user's sleep cycles and a desired wake time have been described using detailed descriptions of embodiments thereof that are provided by way of example and are not intended to limit the scope of the disclosure. The described embodiments comprise different features, not all of which are required in all embodiments of a system and/or method of applying a stimulus of light for a period determined from a comparative analysis of the user's sleep cycles and a desired wake time. Some embodiments of the systems and methods utilize only some of the features or possible combinations of the features. Variations of embodiments of the systems and methods that are described and embodiments of a system and/or method comprising different combinations of features noted in the described embodiments will occur to persons of the art.

It will be appreciated by persons skilled in the art that systems, devices and methods for the provision of a stimulus of light for a period determined from a comparative analysis of the user's sleep cycles and a desired wake time is not limited by what has been particularly shown and described herein above. Rather, the scope of systems, devices and methods is defined by the claims that follow.

Further, with regards to the described methods, certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Therefore, although selected aspects have been illustrated and described in detail, it will be understood that various substitutions and alterations may be made therein without departing from the spirit and scope of the present invention, as defined by the following claims.

What is claimed is:

1. A method for awakening a user from a period of sleep by applying a stimulus of light for a period determined from a comparative analysis of the user's sleep stage and a desired wake time, the method comprising:
setting an alarm time in a personal device that is in communication with a motion sensor, wherein the alarm time represents a desired wake up time for a user of the personal device;
monitoring signals generated by the motion sensor, wherein the monitored signals are representative of movement generated by the user of the personal device when the user is in a stage of light sleep;
determining from the monitored signals that the user has entered a stage of light sleep;
comparing the set alarm time to the timing of the entered stage of light sleep; and
if the alarm time coincides with the timing of the entered stage of light sleep, triggering an alarm to awaken the user, wherein the alarm is a stimulus of light that gradually intensifies.

2. The method of claim 1, wherein the stimulus of light is configured to simulate a dawn.

3. The method of claim 1, wherein the stage of light sleep is a rapid eye movement (“REM”) stage.

4. The method of claim 1, further comprising:
retarding the alarm time; and
holding the stimulus of light at a constant intensity for a period of time before resuming the stimulus.

5. The method of claim 1, further comprising:
retarding the alarm time;
ceasing the stimulus of light; and
initiating a second stimulus of light at a later point in time.

6. The method of claim 1, further comprising:
retarding the alarm time; and
modifying the stimulus of light such that it intensifies at a different rate.

7. A method for awakening a user from a period of sleep by applying a stimulus of light for a period determined from a comparative analysis of the user's sleep cycles and a desired wake time, the method comprising:
setting an alarm time in a personal device comprising a motion sensor, wherein the alarm time represents a desired wake up time for a user of the personal device;
monitoring signals generated by the motion sensor, wherein the monitored signals are representative of movement generated by the user of the personal device when the user is in a stage of light sleep;
determining from the monitored signals that the user has entered a stage of light sleep;
updating a master sleep cycle curve with data collected from the monitored signals;
analyzing the master sleep cycle curve to predict an upcoming stage of light sleep;
comparing the set alarm time to the timing of the upcoming stage of light sleep;
if the alarm time coincides with the timing of the upcoming stage of light sleep, calculating a start time for triggering an alarm to awaken the user; and
triggering the alarm to begin at the start time, wherein the alarm is a stimulus of light that gradually intensifies to simulate a dawn.

8. The method of claim 7, wherein the stimulus of light is configured to simulate a dawn.

9. The method of claim 7, wherein the stage of light sleep is a rapid eye movement (“REM”) stage.

10. The method of claim 7, further comprising:
retarding the alarm time; and
holding the stimulus of light at a constant intensity for a period of time before resuming the stimulus.

11. The method of claim 7, further comprising:
retarding the alarm time;
ceasing the stimulus of light; and
initiating a second stimulus of light at a later point in time.

12. The method of claim 7, further comprising:
retarding the alarm time; and
modifying the stimulus of light such that it intensifies at a different rate.

13. A system for awakening a user from a period of sleep by applying a stimulus of light for a period determined from a comparative analysis of the user's sleep stage and a desired wake time, the system comprising:
a sleep tracker module configured to:
monitor signals generated by a motion sensor, wherein the monitored signals are representative of movement generated by a user of the system when the user is in a stage of light sleep;
determine from the monitored signals that the user has entered a stage of light sleep;
compare a set alarm time to the timing of the entered stage of light sleep; and
if the alarm time coincides with the timing of the entered stage of light sleep, trigger an alarm to awaken the user; and
a dawn simulator module configured to:
initiate an alarm comprising a stimulus of light that gradually intensifies.

14. The system of claim 13, wherein the dawn simulator module is further configured to cause the stimulus of light to simulate a dawn.

15. The system of claim 13, wherein the stage of light sleep is a rapid eye movement (“REM”) stage.

16. The system of claim 13, wherein the sleep tracker module is further configured to retard the alarm time and the dawn simulator module is further configured to hold the stimulus of light at a constant intensity for a period of time before resuming the stimulus.

17. The system of claim 13, wherein the sleep tracker module is further configured to retard the alarm time and the dawn simulator module is further configured to cease the stimulus of light and initiate a second stimulus of light at a later point in time.

18. The system of claim 13, wherein the sleep tracker module is further configured to retard the alarm time and the dawn simulator module is further configured to modify the stimulus of light such that it intensifies at a different rate.

19. A computer program product comprising a computer usable medium having a computer readable program code embodied therein, said computer readable program code adapted to be executed to implement a method for awakening a user from a period of sleep by applying a stimulus of light for a period determined from a comparative analysis of the user's sleep cycles and a desired wake time, said method comprising:
setting an alarm time in a personal device comprising a motion sensor, wherein the alarm time represents a desired wake up time for a user of the personal device;
monitoring signals generated by the motion sensor, wherein the monitored signals are representative of movement generated by the user of the personal device when the user is in a stage of light sleep;
determining from the monitored signals that the user has entered a stage of light sleep;
comparing the set alarm time to the timing of the entered stage of light sleep; and
if the alarm time coincides with the timing of the entered stage of light sleep, triggering an alarm to awaken the user, wherein the alarm is a stimulus of light that gradually intensifies.

20. The computer program product of claim 19, wherein the stimulus of light is configured to simulate a dawn.
